(19) United States
(12) Patent Application Publication
(10) Pub. No.: US 2012/0308212 A1
(43) Pub. Date: Dec. 6, 2012

(54) DEVICE FOR HEATING A FLUID

(75) Inventor: Hans-Peter Bierbaumer, Wien (AT)

(73) Assignee: PHENOM TECHNOLOGIES GMBH, Mondsee (AT)

(21) Appl. No.: 13/521,258

(22) PCT Filed: Jan. 11, 2011
(86) PCT No.: PCT/AT11/00009

§ 371 Date: Aug. 17, 2012

(30) Foreign Application Priority Data
Jan. 11, 2010 (AT) A 17/2010

(51) Int. Cl. F24H 1/10; H05B 3/60; F24D 3/00; F22B 1/30

(52) U.S. Cl. 392/315; 392/314; 392/338; 392/320; 237/56

(57) ABSTRACT

The invention relates to a device (1) for heating a fluid (9), with a housing (2) comprising a housing shell (3), a housing base (4) and a housing cover (5), with at least one inlet opening (11) and at least one outlet opening (13) for the fluid (9), and at least two electrodes are disposed in the housing (2) at a distance (25) apart from one another, which are each electrically conductively connected to a pole of at least one pulse generator (20). A smoothing section (38) for the fluid (9) is provided after the electrode(s) in the flow direction—arrow (27)—of the fluid (9).

The invention relates to a device for heating a fluid, with a housing comprising a housing shell, a housing base and a housing cover, with at least one inlet opening and at least one outlet opening for the fluid, and at least two electrodes are disposed in the housing at a distance apart from one another, in particular at least one anode and at least one cathode, which are each electrically conductively connected to a pole of at least one pulse generator, a heating system comprising at least one device for conveying a first fluid, at least one device for heating a fluid, at least one heat exchanger in which the heat generated by the fluid is transmitted to another fluid, as well as the use of the device for heating a fluid.

Methods of electrical heating are already known from the prior art. They can be sub-divided into resistance heating, arc heating, induction heating systems, dielectric heating systems, electron heating systems, laser heating systems and combination heating system. For example, RU 21 57 861 C discloses a system for recovering thermal energy, hydrogen and oxygen, which operates on a physical-chemical based technology. This device comprises a housing made from a dielectric material, which is provided with an integrally cast, cylindrically conical cam with an end-to-end orifice which, together with the housing, constitutes the anode and cathode chamber. The anode is provided in the form of a flat ring with orifices which sits in the anode chamber and is connected to the positive pole of the power supply source. The rod-shaped cathode is made from heat-resistant material and is inserted in an externally threaded rod, together with which it can be centered in the orifice in the cover by means of a threaded orifice in the housing leading to the interelectrode chamber and is connected to the negative pole of the power supply source. The inlet connectors for initiating operation are disposed in the middle part of the anode chamber.

The disadvantage of the methods and devices known to date as a means of electrically heating solid bodies, liquids and gases resides in the high energy intensity of the heating process. Above all, this results in poor levels of efficiency.

Accordingly, the objective of this invention is to propose an option for heating a fluid which is more economical.

This objective is achieved by the invention, independently in each case, by the device for heating a fluid mentioned above, the heating system and the use of the device proposed by the invention as a means of heating a building, and in the case of the device for heating a fluid, at least one smoothing zone for the fluid is provided following the electrode or electrodes in the flow direction of the fluid, in particular the at least one cathode or the at least one anode, and the heating system comprises at least one device for heating a fluid as proposed by the invention.

The advantage of this is that it at least partially prevents larger bubbles from forming in the fluid across the smoothing section. This means that energy introduced into the system is not used for partially damping the fluid. Furthermore, this also makes for a more uniform distribution of the heat transmitted to the fluid. It is a known fact that bubbles have a certain heat-insulating effect. Preventing bubbles results in a more homogenous temperature range within the fluid. Moreover, it also means that because a more homogenous temperature distribution can be obtained in the fluid, thereby enabling “hotspots” to be avoided, the device can be operated with a lower energy input via the electrodes, which in turn enables the degree of efficiency to be improved and results in more economic operation of the device.

The smoothing section is preferably disposed in the housing. On the one hand, this makes for a more compact construction of the device and, on the other hand, additional eddying cannot occur in the region of flow connections between the housing in which the electrodes are disposed and the smoothing section.

The smoothing section preferably has a length which is 100%, in particular 150%, to 500%, in particular 350%, longer than a longitudinal extension of at least one of the at least two electrodes, in particular the anode or the cathode, in the flow direction of the fluid. During testing of the device, it has been specifically established that smoothing sections which are too short do not produce the desired effect overall in terms of maintenance. Surprisingly, however, it was found that smoothing sections which are too long go hand in hand with a reduction in economic operation, even though they should actually improve the effects outlined above. The reason for this has not been established as yet.

In the region of the smoothing section, the housing may have an at least partially bigger clearance width than the region of the housing in which the at least two electrodes are disposed, in particular the cathode and the anode. Due to this cross-sectional widening, the flow speed of the fluid in the region of the smoothing section is lower than in the region of the housing in which the electrodes are disposed, which means that the smoothing section as a whole can be made shorter because the fluid “dwells” for a longer time in the smoothing section which means that a longer time is available to impart smoothness to the fluid. At the same time, a higher pressure acts on any vapor or gas bubbles in the smoothing section, so that the latter are more effectively reduced in size or at least partially destroyed in this cross-sectional widening.

Another option is to dispose at least one deflector plate in the smoothing zone in order to impart a pre-definable flow to the fluid which is conducive to smoothing the fluid.

Another possibility is to provide at least one light-emitting diode in or alongside the smoothing section, in particular a high-power light-emitting diode. It was observed that radiating light in at a specific frequency or in a specific frequency range resulted in a significant reduction of large bubbles in the fluid by generating bubbles of micro-dimensions. It is assumed that radiating into the fluid at specific frequencies causes interactions to occur with the molecules of the fluid, thereby at least partially inducing natural vibrations in the molecule, and this vibrating behavior in the molecules of the fluid at least largely prevents or avoids the formation of large bubbles in the same way as the formation of large gas bubbles in a fluid is prevented using mechanical devices, such as agitators for example, or boiling chips such as used in chemistry to prevent boiling delays.

If using water as the heat-carrying medium, it has been found to be of advantage if the at least one light-emitting diode emits white light.

However, it is also possible to dispose several light-emitting diodes in or along the smoothing section, which emit light in a different wavelength spectrum. On the one hand, this enables the frequency to be adapted to the heat-carrying medium, i.e. its molecules or molecule structures, more easily because it is known that molecular vibrations or the excitation of rotational states in the molecule requires specific wavelengths. By providing a wavelength spectrum which is broader, reliability is improved in terms of achieving the effect. On the other hand, this makes it possible, in particular if an electrolyte is added to the heat-carrying medium, i.e. water for example, to provide heat in the region of the electrodes, for these electrolyte ions present in the heat-carrying medium to contribute to preventing the formation of bubbles.

The light-emitting diodes or the light-emitting diode are/is preferably disposed in a peripheral region of the housing shell, so that a better distribution of the amount of light radiated into the fluid is achieved due to corresponding refractory effects or diffraction effects.

Based on another embodiment, the light-emitting diodes are electrically conductively connected to a device for generating intermittently occurring light. Similarly to a stroboscope, therefore, light pulses are introduced into the fluid. During the pulse pauses, the excited fluid particles are able to revert to the original state, thereby enabling the effectiveness of the process of destroying the large gas bubbles to be improved.

In order to improve the effectiveness of the process of applying voltage pulses to the fluid in the region of the housing in which the electrodes are disposed, at least one of the at least two electrodes, in particular the anode, is based on a basket-shaped design, and in another embodiment, it is preferable if at least one of the least two electrodes is disposed at least partially inside the basket-shaped electrode, in particular the cathode is disposed at least partially inside this basket-shaped anode. This enables a more homogeneous distribution of the charge carriers introduced into the fluid to be improved.

It was also observed that the effectiveness of the device and as a consequence the heating system can be improved if the distance between the at least two electrodes, in particular between the cathode and the anode, is at least 5 mm, in particular at least 7 mm. This is also of particular importance with respect to the formation of bubbles so that the selected distance has a supporting effect on the smoothing section.

Based on the preferred embodiment of the device proposed by the invention, the housing shell is of a cylindrical design, leading to a positive flow behavior of the fluid by avoiding edges, etc., thereby avoiding eddying in the fluid.

Another approach is to dispose at least one of the least two electrodes in the housing so that it can be moved in a relative displacement towards the other electrode, in particular the anode is moved relative to the cathode and/or the cathode relative to the anode. This enables the distance between the at least two electrodes to be readjusted, even during operation of the device, in order to improve the effectiveness of the device proposed by the invention.

Due to the voltage pulses applied to the fluid, a vibrating behavior is excited in the molecules in the system, i.e. in the molecular structure of the fluid. The prevailing pattern of the molecules in the fluid is destroyed as a result and the molecules strive to restore this ordered state, which is dependent on the respective temperature of the fluid. It was observed that the degree of efficiency with which the fluid is heated with the aid of the voltage pulses could be improved if uniform pulses were not transmitted over time, i.e. voltage pulses with a constant amplitude and/or constant pulse duration, and if instead, the pulse generator emitted variable voltage pulses. As a result of this variability, the behavior of the fluid, namely its attempt to establish a specific order in the system, is constantly thwarted. This enabled the efficiency of the device to be improved.

It is also of advantage if the pulse generator generates voltage pulses with an amplitude selected from a range with a lower limit of von 330 V, in particular 500 V, and an upper limit of 1500 V, in particular 1200 V. Precisely this range is of advantage if water is used as a heat-carrying medium, i.e. as fluid, with a view to improving heating.

In order to prevent the molecules from establishing a specific ordered state in the fluid, the pulse generator may comprise a random number generator, which may be based on hardware or software, by means of which the voltage pulses can be configured on a variable basis.

Based on a preferred embodiment, the pulse generator generates voltage pulses with a steep rising flank of at least 25 V/μs. A preferred embodiment in this respect is one where the pulse generator is configured to emit rectangular voltage pulses. Due to the steep rising flank of the pulses used to obtain maximum amplitude, the energy can be transmitted to the system, i.e. fluid, in the manner of an “explosion” which enables premature restructuring of the molecules to be prevented more easily, thereby enabling a higher energy yield to be obtained.

The pulse generator may be configured so that it emits voltage pulses at a pulse frequency selected from a range with a lower limit of 20 Hz, in particular 800 Hz, preferably 2530 Hz, and an upper limit of 20 kHz, in particular 11 kHz, or voltage pulses with a pulse duration selected from a range with a lower limit of 2 ns, in particular 10 ns, and an upper limit of 10 μs, in particular 5 μs, or generates voltage pulses with a pulse pause selected from a range with a lower limit of 2 μs, in particular 5 μs, and an upper limit of 20 μs, in particular 8 μs. Again, effectiveness was improved as a result of these individual variants of the invention, either individually or used in any combination with one another, if using water as a fluid for carrying heat.

To prevent the molecules of the fluid from assuming an ordered state, the pulse generator is configured to generate variable pulse pauses so that the voltage pulses are applied at a variable frequency.

At least one laser may also be disposed in the smoothing section. This embodiment of the invention is preferred if an electrolyte is added to the heat-carrying fluid, in particular water, which is present in the fluid in the form of cations and anions. The laser is able to activate these ions, thereby improving the conductivity of the fluid and the effectiveness of the process of transmitting voltage pulses into the fluid.

The laser preferably emits light at a frequency selected from a range with a lower limit of 300 THz, in particular 410 THz, and an upper limit of 550 THz, in particular 490 THz.

Another option in this respect is for the laser to be connected to a device for generating intermittently occurring light, and in the case of one embodiment the laser emits light pulses with a pulse duration selected from a range with a lower limit of 20 μs, in particular 33 μs, and an upper limit of 100 μs, in particular 50 μs. Similarly to the embodiment of the invention using intermittently occurring light from the light-emitting diode(s), it was found that in practice, intermittently occurring laser light improves the heating performance of the device and the heating system, in particular at a frequency within the specified range.

The pulse generator is preferably provided with a regulating and/or control module in order to obtain greater accuracy of the voltage pulses transmitted to the fluid, in particular the shape of the voltage pulses. As an alternative to this, the pulse generator may also be connected to an external regulating and/or control device for the same purpose.

Based on a preferred embodiment of the heating system, the heat exchanger is provided in the form of a radiator, in which case this heating system is designed in particular for heating the ambient air of a building.

To provide a clearer understanding, the invention will be described in more detail with reference to the appended drawings.

These are schematically simplified diagrams illustrating the following:

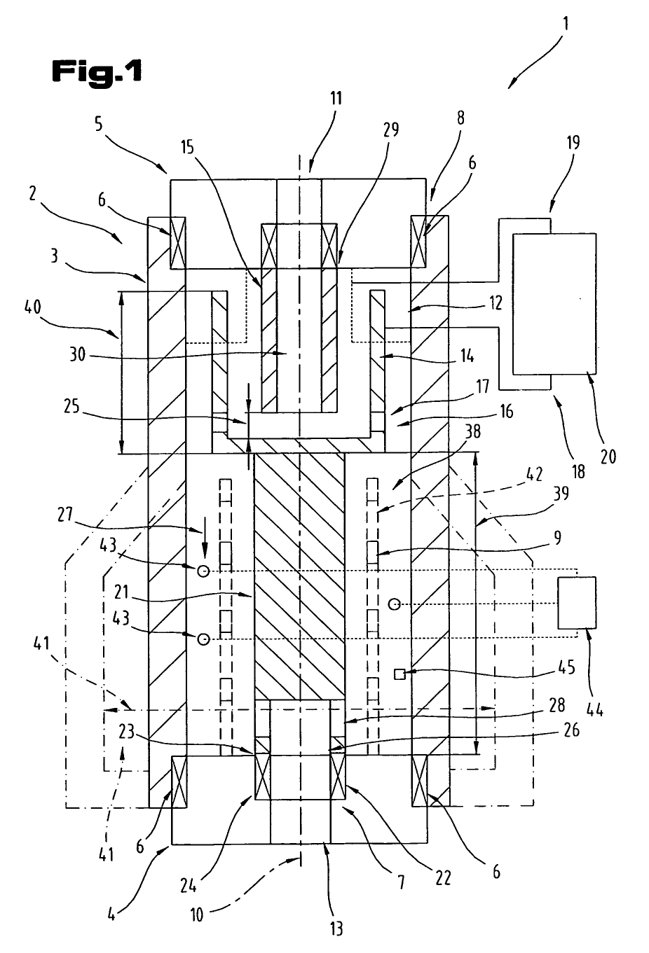

FIG. 1 illustrates an embodiment of a device for heating a fluid;

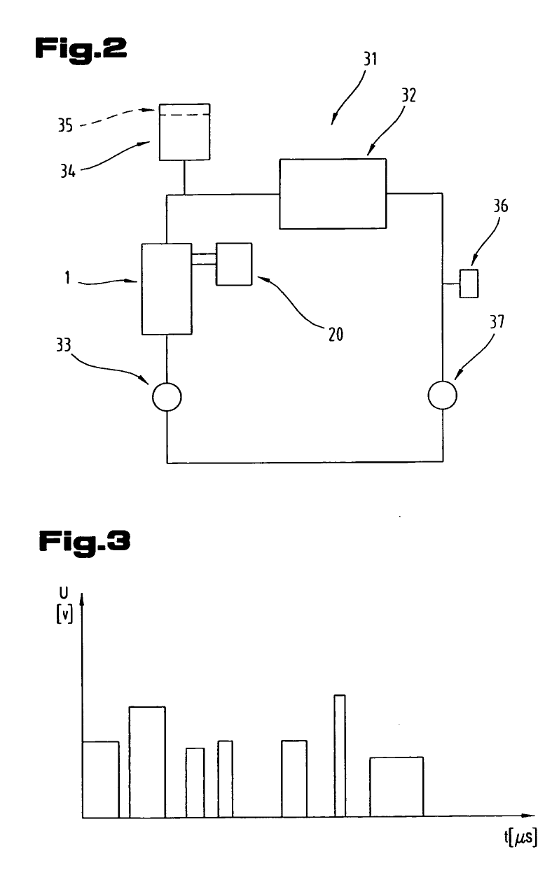

FIG. 2 shows a heating system;

FIG. 3 shows a variant of a voltage pulse pattern;

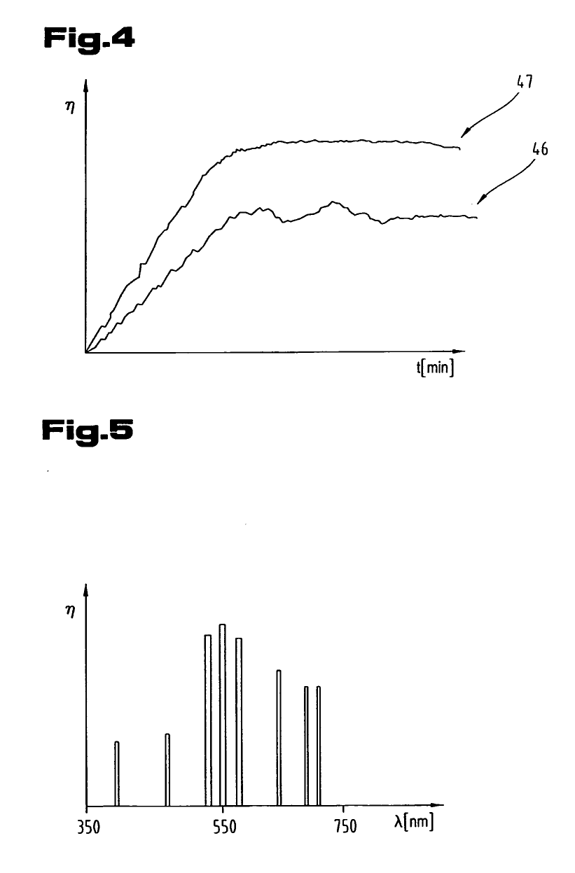

FIG. 4 illustrates how applying variable pulses to the fluid influences the degree of efficiency.

FIG. 5 illustrates how the wavelength of the light emitted by the light-emitting diodes influences the degree of efficiency.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 illustrates a device 1 as proposed by the invention for heating a fluid, preferably water. It comprises a housing 2, comprising a housing shell 3, as well as a housing base 4 and a housing cover 5. The housing 2, i.e. the housing shell 3 and/or the housing base 4 and/or the housing cover 5, are preferably made from a dielectric material, for example a plastic, e.g. PE, PP, PVC, PS, Plexiglas etc.

As may be seen from FIG. 1, both the housing base 4 and the housing cover 5 are each screwed by means of an internal thread in the housing shell 3—a thread 6 is provided in each case at each of the two end regions 7, 8 of the housing shell 3—and a co-operating external thread on the housing base 4 and on the housing cover 5 to the housing shell 3 so that the housing base 4 and the housing cover 5 can be removed from the housing shell 3. Instead of the screw connections, it would naturally also be possible to enable this removal by simply sliding the housing base 4 or housing cover 5 into the housing shell 3, in which case care must be taken with this embodiment to ensure that the requisite tight seal is obtained, e.g. by providing sealing rings or similar, such as O-rings. In addition, however, it is also possible for the housing base 4 and/or the housing cover 5 to be disposed in the housing shell 3 by means of a press-fit connection or to be connected to it by some other means, e.g. welding, etc. Another option is one where only the housing base 4 or only the housing cover 5 can be removed from the housing shell 3. Yet another option is for the housing 2 to be designed as an integral part with the housing base 4 and/or housing cover 5.

Based on the embodiment of the device 1 illustrated in FIG. 1, the housing 2 is cylindrical in shape. Naturally, however, it would also be possible for the housing 2 to be of a different three-dimensional shape, e.g. cubic, etc. The cylindrical design enables the flow resistance opposing a fluid 9 conveyed through the device 1, in particular water, to be reduced.

The housing cover 5 has a recess along a longitudinal mid-axis 10. e.g. in the form of a bore, serving as an inlet opening 11 for the fluid 9 into the device 1, i.e. into a reaction chamber 12 of the device 1.

An outlet opening 13 in the form of an axial bore is provided in the housing base 4, ensuring that the fluid 9 is able to drain out of the reaction chamber 12.

However, both the inlet opening 11 and the outlet opening 13 may be disposed at a different point in the housing 2 of the device 1, for example in the housing shell 3, or radially in the housing base 4 or housing cover 5, in order to impart a tangential flow to the incoming fluid 9.

Alternatively, more than one inlet opening 11 and/or more than one outlet opening 13 could also be provided, in which case an opening in both the axial and/or radial direction would be possible, for example one or more inlet openings 11 in the axial direction and one or more inlet openings 11 in the radial direction and/or one or more outlet openings 13 in the axial direction and one or more outlet openings 13 in the radial direction.

At least one anode 14 and at least one cathode 15 are disposed in the reaction chamber 12. The anode 14 is preferably of a basket-shaped design and the at least one cathode 15 is disposed at least partially inside the space defined by the anode 14, as illustrated in FIG. 1. To facilitate through-flow of the fluid 9, the anode 14 may be provided with one or more orifices 17 in an end region 16 facing the housing base 4, preferably oriented in the radial direction so that the fluid 9 leaves the region inside the reaction chamber 12 defined by the anode 14 deflected in the direction perpendicular to the longitudinal mid-axis 10. However, another option is for the anode 14 to be based on a lattice-type design or, alternatively or in addition to the orifice 17 or orifices 17, such orifices could also be provided in the part of the anode 14 facing the container base 4, in other words the “base” of the basket-shaped anode 14. In this connection, it is possible for the anode 14 as well as the cathode 15 to be of a bar-shaped design in one embodiment. Also, several anodes 14 and cathodes 15 may be provided, in which case it is preferable to opt for an alternating arrangement of the anodes 14 and cathodes 15, thereby forming pairs comprising an anode 14 and a cathode 15.

The at least one anode 14 is electrically conductively connected to a positive pole 18 and the at least one cathode 16 to a negative pole 19 of a pulse generator 20.

The distance 25 between the cathode 15 and the anode 14 is at least 5 mm, in particular at least 7 mm.

As illustrated in FIG. 1, the anode 14 in this embodiment is disposed in the reaction chamber 12 at a distance apart from the housing base 4. To obtain this spacing, a dome-shaped shoulder 21 is provided in the housing base 4 in the region of the outlet opening 13 for the fluid 9 from the reaction chamber 12, which can be used to adjust the height of the at least one anode 14. In particular, this shoulder 21 is in turn of a rotationally symmetrical, bolt-shaped design and is retained in a central bore 22 in the housing base 4.

However, this shoulder 21 may also be based on any other geometric shape, for example a prism, in which case this bore 22 will be of a shape matching the external circumference of the shoulder 21.

It is also possible that this shoulder 21 does not extend through the housing base 4 and instead is placed on it, e.g. is glued to it or connected to the housing base 4 by some other joining technique, such as welding for example. In this example of an embodiment, this shoulder 21 is provided with an external thread 23, which locates in an internal thread 24 of the bore 22. This enables the height of this shoulder 21 to be adjusted to a certain degree so that a distance 25 between the anode 14 and cathode 15 can be adjusted, in other words the depth by which the cathode 14 extends into the basket-shaped anode 14 in this embodiment.

In addition to screwing the shoulder 21 in and out, another option is to design it so that it slides into the bore 22, thereby offering another way of adjusting this distance 25.

Along the course of the longitudinal mid-axis 10, this shoulder 21, which is preferably also made from a dielectric material, has an opening 26 which does not extend in the direction of the longitudinal axis 10 and which is disposed in the flow direction of the fluid 9 (arrow 27) behind the opening 10 in the housing base 4.

At least one radial bore 28 is provided in the shoulder 21 in the region of the housing base 4, through which the fluid 9 is able to flow out of the reaction chamber 12. However, it would also be possible for the outlet opening 13 to be disposed not centrally in the housing base but off-center and adjacent to the mount for the shoulder 21 in the housing base, in which case this/these radial bore(s) 28 can be dispensed with. However, the advantage of the first of the above-mentioned variants is that the dwell time of the fluid 9 in the reaction chamber 12 can be lengthened, which is of advantage in terms of smoothing the fluid 9 in the context of the invention. Another option is to provide several radial bores 28 at different heights in the shoulder 21.

In this respect, it is possible for the housing base 4 and the shoulder 21 to be of an integral design in one embodiment, in which case, the height adjustment and hence the adjustment of the distance 25 can be obtained by screwing the housing base 4 into the housing shell 3.

The anode 14 may also be designed so that it at least partially surrounds the shoulder 21. Towards the bottom, i.e. in the direction towards the housing base 4, the anode 14 in this variant may be fixed in its vertical position by an appropriate fixing means, e.g. a nut or a circumferentially extending web or such like. In the simplest case, the anode 14 may sit on this fixing means so that it can be removed. However, it may naturally also be connected to this fixing means.

Another option is one where the anode 14, although based on a basket-shaped design, extends only in the direction towards the housing base 4. In this case, the cathode 15 has a surface extension extending parallel with the base of the anode 14, although it could also be fitted with its active surface extending horizontally only as opposed to the vertical orientation of this surface illustrated in FIG. 1.

The cathode 15 in this embodiment is likewise cylindrical. The cathode 15 is also retained in an axial bore 29 of the housing cover 5, and this axial bore 29 may naturally have a bigger diameter than the inlet opening 11 for the fluid 9.

This cathode 15 is preferably designed so that it can be screwed into or inserted in the axial bore 29. Alternatively, it would naturally also be possible for the cathode 15 to be connected to the housing cover 5 so that it cannot be moved.

To enable the fluid 9 to enter the reaction chamber 12, this cathode 15 may have a centrally disposed, continuous bore 30 in the flow direction of the fluid 9 (arrow 26) adjoining the inlet opening 11.

At this stage, it should be pointed out that the term bore is used in these descriptions of the subject matter but it would naturally be possible to choose different geometries for the object inserted in it and these bores may therefore generally be termed recesses with cross-sections adapted accordingly.

The cathode 15 may be entirely or partially covered by the housing cover 5 in the radial direction, in which case it is of advantage to provide a co-operating bore ore recess in the housing cover 5 with a bigger diameter than the axial bore 29, to enable a cathode chamber to be provided in the region of the cathode 15, as indicated by broken lines in FIG. 1. The housing cover 5 may also cover the cathode 15 in the direction towards the reaction chamber 12.

It would also be possible to provide at least one inlet opening 11 in an off-center disposition in the housing cover 5 so that the fluid does not have to flow through the cathode 15 and hence the axial bore 29.

Another option is for the cathode 15 to be closed in the bottom end region pointing in the direction towards the container base 4, in which case at least one radial bore is provided in the cathode 15 to allow the fluid 9 to pass into the reaction chamber 12.

As already mentioned, it is possible to provide several individual anodes 14 and several individual cathodes 15 in the reaction chamber 12, for example in the form of electrode plates or lattice-type electrodes, in which case these may optionally form packets.

Generally speaking, the anode 14 and the cathode 15 may be disposed one after the other in the flow direction of the fluid 9 or adjacent to one another.

Another option is not to dispose the housing base 4 and/or housing cover 5 in an inner bore of the housing shell 3 but conversely, to dispose them extending externally on the housing shell 3 in the manner of a push-on or screw-on cover 5.

The size of the reaction chamber 12 is variable, especially as regards the desired heating power of the device 1, which may be 5 kW to 40 kW, for example.

This also enables the actual flow speed of the fluid 9 in the reaction chamber 12 to be influenced.

The housing base 4 and/or the housing cover 5 may have stud-type projections at its outer ends, for example to facilitate connection of the heat generator 1 to a heating circuit or similar. To this end, these stud-type projections of the housing base 4 and housing cover 5 may be provided with appropriate threads. Naturally, it would also be possible to use a standard screw connection with clamping nuts or similar, e.g. a conical face pipe union of the type known in the heating industry.

Based on one embodiment, it is possible for the shoulder 21 to extend through the housing base 4 so that it can be operated from outside, i.e. outside of the reaction chamber 12, for example in order to correct the set distance 25 between the anode 14 and cathode 15 subsequently or to set it from outside.

Yet another option is to enable the height of the cathode 15 to be adjusted as well as that of the anode 14 or to use a design in which only cathode 15 can be displaced in terms of its position relative to the anode 14.

In this respect, it should be pointed out that the displacement could naturally be motor-driven or may be done manually only, for which purpose the shoulder 21 may be provided with an appropriate drive, for example. This drive may be based on a micro-electronic design, given that the absolute distances of the displacement during operation of the device 1 are not that great but should be understood as being nothing more than fine adjustments provided the correct distance 25 between the anode 14 and cathode 15 was set during initial operation. It is merely a question of compensating for any heat expansion which might have occurred with a view to further improving or optimizing the efficiency of the device 1.

Depending on the desired power rating of the device 1, the distance 25 between the at least one anode 14 and the at least one cathode 15 may be selected from a range with a lower limit of 7 mm and an upper limit of 10 cm or with a lower limit of 10 mm and an upper limit of 5 cm, the energy yield within this range being surprisingly high.

Both the anode 14 and the cathode 16 are usually made from a metal material.

The anode 14 may also be mounted in the housing in a different manner, for example likewise by means of the container cover 5, in which case the shoulder 21 can be dispensed with so that the region of the reaction chamber 12 after the electrodes can be made bigger or the housing made to a more compact design. Another option is for the anode 14 to be supported on a projection of the housing shell 3 pointing in the direction towards the longitudinal mid-axis 10.

The flow direction of the fluid 9 in terms of the intake may also be reversed, in which case this fluid 9 is fed in through the shoulder 21. To this end, an outlet opening may be provided in the anode 14 in the region where it adjoins the shoulder 21, via which the fluid 9 is fed into the region between the anode 14 and cathode 15. After flowing through this region, the fluid 9 is deflected in the region of the container cover 5 and fed back out of the reaction chamber 12 via at least one of the off-center outlet openings in the container base.

FIG. 2 illustrates the preferred possible application of the device 1 proposed by the invention. It is disposed in the circulation circuit of a heating system 31, e.g. a central heating system or a radiator 32. The radiator 32 may be made from any material, in particular stainless steel, copper or similar.

The device 1 further comprises the pulse generator 20. Naturally, other devices may be provided as necessary, such as at least one pump 33, at least one expansion tank 34, optionally a gas absorber 35, over-pressure safety features, control and measuring devices, etc., of the type known from heat engineering in the central heating sector. It would naturally also be possible to incorporate other control units 37.

The pulse generator 20 may be based on an electro-mechanical or electronic design. In the case of an electro-mechanical design, the pulse generator comprises an electric motor, a voltage pulse generator and a pump, in particular a hydraulic pump, these elements of the pulse generator 20 being disposed in the specified order on a common shaft. By contrast with the electro-mechanical pulse generator 20, the electronic pulse generator 20 is preferably of a modular design, and in a first power-feed module, e.g. a transformer, the electrical energy fed in from the grid or other power sources, e.g. accumulator, etc., is galvanically separated from the earthed power system. In the situation where alternating current is fed in, the supplied energy is optionally rectified in a rectifier module, e.g. with conventional rectifier elements known from the prior art. A supply module is conductively connected to the power-feed module or rectifier module, by means of which the continuous direct voltage is transformed into a pulsing direct voltage. This pulsing direct voltage is then applied via the anode 14 and cathode 15 to the fluid 9 in the gap between the electrodes. For regulating and/or control purposes, it is preferable to provide a regulating and/or control module comprising individual capacitors, transistors, at least one IGBT, which in the case of one embodiment may be provided in the form of a circuit board, for example. This regulating and/or control module regulates and/or controls pulse widths, pulse durations as well as the repeat frequency of the voltage pulses, for example. To this end, a temperature taken from a temperature regulating circuit may be applied as the regulating criterion, and this temperature regulating circuit receives data based on the temperature of the fluid 9, in particular the desired temperature of the fluid 9 in the heating system 31. In this heating system 31, it is possible to provide thermostats as temperature sensors of a type known per se.

Other input variables used for regulating purposes might include chemical and physical parameters, for example the pH value of the fluid 9 or a pressure or a concentration of a chemical additive for the fluid 9, for example a lye, or the electrical conductivity of the fluid 9.

The voltage pulses can therefore be adjusted in terms of both pulse shape and amplitude, and in particular the steepness of the flanks (dU/dt) of the voltage pulses can be adjusted and regulated from the pulse generator 20, in particular the rising flank and/or the trailing flank. It is therefore possible to set up voltage pulses with a steeply rising and flat or gently trailing flank, in particular rectangular pulses.

As already mentioned, this electronic pulse generator 20 may be supplied with primary energy, i.e. electric current, directly from the supply network of the power supplier. It would also be possible to feed in different signal shapes with different frequencies via an intermediate circuit from any power source, for which purpose transistors etc., known from the prior art are used in the electronic pulse generator 20 in order to obtain the ultimately desired pulse shape.

In order to prevent overheating of the pulse generator 20, it may be provided with an appropriate cooling module, for example in the form of cooling ribs, e.g. made from aluminum sections.

The operating mode of the device 1 can be summarized as follows. The pulse generator 20 is switched to the supply network, i.e. the power network. The voltage pulses generated by the latter are transmitted via the anode 14 and cathode 15 to the fluid 9 in the flow circuit of the heating system 31, where they generate the desired heat in the fluid 9. As this takes place, the fluid 9 is kept in circulation by the pump 35, which may be provided as a component of the electro-mechanical pulse generator 20 on the one hand or, if using an electronic pulse generator, as a separate component of the heating system 31. The fluid 9 is preferably circulated in a closed circuit through the circulation units of the heating system 31 and hence also through the device 1, in particular its reaction chamber 12.

At this stage, it should be pointed out that instead of a radiator 32, it would also be possible to use other types of heat exchanger, for example plate heat exchangers with a large surface area, tube heat exchangers, etc., where the heat from the fluid primarily heated by the device 1 is transmitted to a secondary fluid in a known manner, in order to heat houses, industrial installations or similar, for example.

It has proved to be of advantage if the fluid 9 has a basic medium added to it so that it has a basic pH value. In this respect, the pH value may be selected from a range with a lower limit of 7.1 and an upper limit of 12 or more especially preferably with a lower limit of 9 and an upper limit of 11. In order to create the basic pH values, any basic medium may be used in principle, but particularly preferred are caustic soda, potash, calcium hydroxide or calcium carbonate.

As illustrated in FIG. 1, the device is disposed after the at least one anode 14 in the flow direction of the fluid 9 (arrow 27) or, if the anode 14 and cathode 15 are disposed in the reverse arrangement so that the cathode 15 is disposed after the anode 14 in the flow direction of the fluid 9 in the reaction chamber 12, the smoothing section 38 for the fluid 9 is provided after the cathode 15.

The term “smoothing” within the context of the invention is intended to mean that any larger gas or vapor bubbles which might have been generated due to partial evaporation of the fluid 9 when voltage pulses were applied to the fluid 9 between the anode 14 and cathode 15 are reduced or made smaller in the fluid 9 to micro-dimensions during the course of the smoothing section 38.

The expression “smoothing section” should be construed as meaning a volume in which the fluid 9 is disposed for smoothing purposes, and which is preferably disposed immediately adjoining the region of the housing 2 in which the electrodes are disposed in the flow direction of the fluid 9.

In the case of the embodiment illustrated in FIG. 1, the smoothing section 38 is disposed in the housing 2 itself. Another option would be to provide this smoothing section 38 as a separate component adjoining the housing 2. In this case, given the cylindrical shape of the device 1 illustrated in FIG. 1, another housing shell is connected to the housing 3, for example screwed to it, and the screw fitting may optionally be provided by means of an appropriate thread on the housing base 4 of the device 1.

This smoothing section 38 preferably has a length 39 which, in the case of the embodiment illustrated, extends from the bottom face of the anode 14 pointing towards the housing base 4 to the surface of the container base 4 pointing in the direction towards the anode 14, as illustrated in FIG. 1. In general terms, the smoothing section 38 in this embodiment is disposed between the electrodes, i.e. the lowermost electrode in the direction towards the housing base, and the housing base 4.

The length 39 is 100% to 500% longer than a longitudinal extension 40 of the anode 14 or corresponding electrode. In particular, this smoothing section 38 has a length 39 which is 150% to 350% longer than the longitudinal extension 40 of the anode 14 in order to improve the degree of efficiency of the device 1.

Based on another embodiment of the invention indicated by broken lines in FIG. 1, the smoothing section 38 has an at least partially bigger clearance width 41 than the region of the housing 2, i.e. reaction chamber 12, in which the electrodes are disposed, i.e. the cathode 15 and the anode 14. Accordingly, it is possible for the housing base 4 to be selected so that it is also bigger in terms of its diameter or, as indicated by broken lines in FIG. 1, this clearance width 41 can be reduced in the region of the housing base 4 to the value corresponding to the clearance width in the region of the electrodes.

The widening of the cross-section, i.e. the widening of the clearance width 41, preferably extends unchanged following a transition region into the region of the housing base 4, with a view to avoiding additional eddies in the smoothing section 38.

To improve the effect still further, i.e. impart further smoothness to the fluid 9, at least one deflector plate 42 may be disposed in this smoothing section 38 or smoothing zone of the housing 2. This deflector plate 42 may be connected to the housing shell 3 and/or, as indicated by broken lines in FIG. 1, to the housing base 4, and radial bores may be provided in the deflector plate 42 across the length of the deflector plate 42 in the direction of the length 39 of the smoothing section 38 in order to permit a flow connection between the individual regions of the smoothing section 38 that are separated from one another. Alternatively, however, a separate outlet opening 13 may be provided in the housing base 4 for the individual separated regions of the smoothing section 38.

In the embodiment of the invention illustrated in FIG. 1, the deflector plate 42 is cylindrical in shape. However, it would also be possible to provide individual, mutually separate deflector plates 42 in the smoothing section 38. The expression “deflector plate” as used within the meaning of the invention should also be construed as including other types of flow deflector elements, for example of the lattice, knitted or net type.

Based on another embodiment of the invention, at least one light-emitting diode 43 is provided in the smoothing section 38, and in the case of the embodiment illustrated in FIG. 1, three light-emitting diodes 43 are provided. These light-emitting diodes 43 preferably emit white light. In the layout of light-emitting diodes 43 illustrated in FIG. 1, the latter are distributed along the length 39 of the smoothing section 38, i.e. they are disposed at different heights in the reaction chamber 12. However, another possibility would be to dispose these light-emitting diodes 43 at the same height, although the former embodiment of the invention is preferred.

The light-emitting diodes 43 may emit light in the same wavelength range. Alternatively, for the reasons outlined above, one option is to use light-emitting diodes 43 which emit light in different wavelength ranges and in this embodiment, the light-emitting diodes 43 emit a light other than white, for example at least one light-emitting diode 43 may emit blue light and at least one other light-emitting diode 43 emits red light.

In the variant illustrated in FIG. 1, the light-emitting diodes 43 are disposed in the peripheral region of the housing shell 3. In principle, however, these light-emitting diodes 43 could also be disposed in the housing shell 3 or offset farther in the direction towards longitudinal mid-axis 10, and yet another option is for these light-emitting diodes 43 to be disposed at different distances from the housing shell 3 in the reaction chamber 12, i.e. the smoothing section 38.

Based on one particular embodiment of the invention, at least one of the light-emitting diodes 43, preferably all of them, is electrically conductively connected to a device 44 configured to emit an intermittent light. A pulse pause of the light pulses may be selected from a range with a lower limit of 1 μs and an upper limit of 50 μs. A pulse duration of the light pulses may be selected from a range with a lower limit of 20 ns and an upper limit of 20 μs.

The pulse frequency as well as the pulse duration and the pulse pauses of the light pulses emitted by the light-emitting diodes 43 may be selected so as to remain constant but these light pulses are preferably emitted with at least one variable value, i.e. the pulse duration and/or the pulse pauses changes when the light pulses are being applied to the fluid 9. This change may be regular or totally random.

In order to achieve this, an appropriate random number generator may be provided in the device 44, or this could also be achieved on the basis of software using appropriate EDP programs.

In terms of pulse frequencies for the voltage pulses, it has proved to be of particular advantage to opt for frequencies selected from a range of with an upper limit of 500 Hz and a lower limit of 100 Hz, in particular with an upper limit of 300 Hz and a lower limit of 150 Hz.

The pulse duration of the voltage pulses may be selected from a range with a lower limit of 10 μs and an upper limit of 250 μs, in particular from a range with a lower limit of 40 μs and an upper limit of 200 μs.

The pulse amplitude of the voltage pulses may be selected from a range with a lower limit of 330 V and an upper limit of 1500 V, in particular from a range with a lower limit of 500 V and an upper limit of 1200 V.

The pulse pauses between the voltage pulses may be selected from a range with a lower limit of 2 μs and an upper limit of 20 μs, in particular from a range with a lower limit of 5 μs and an upper limit of 8 μs.

Based on one particular embodiment of the invention, the pulse generator 20 is configured to emit variable voltage pulses. By this is meant that the pulse frequency and/or the pulse duration and/or the pulse pauses and/or the amplitude of the voltage pulses may vary over time so that the voltage pulses are not emitted in a regular pattern. In this respect, FIG. 3 illustrates a sequence of rectangular pulses with a variable pulse configuration in this context. The parameters for the voltage and pulse duration are selected from the ranges specified above. Since this is merely one example, no specific values are given in the diagram. It is merely intended to illustrate a pattern for voltage pulses.

It is also possible that within a group of consecutive voltage pulses, the voltage does not drop to zero but remains at a pre-definable level after a voltage pulse before the next voltage pulse follows.

Naturally, the example illustrated in FIG. 3 is merely intended to represent different voltage pulse patterns. The amplitude of the voltage pulses, the duration of the voltage pulses as well as the pulse pauses may be selected from the ranges specified above.

In order to achieve this, the pulse generator 20 may comprise a random number generator or alternatively appropriate software means may be provided for this purpose.

As already mentioned, it is preferable to use rectangular voltage pulses. However, it would be possible within the scope of the invention to use voltage pulses with a steep rising flank of at least 25 V/μs.

The pulse frequency of the voltage pulses may also be selected from a range with a lower limit of 20 Hz, in particular 800 Hz, preferably 2530 Hz, and an upper limit of 20 kHz, in particular 11 kHz.

The trailing flank of the voltage pulses may also be selected so that it is as steep as the rising flank, but it is possible to opt for other degrees of steepness of at least 15 V/μs, although this is not the preferred variant of the invention.

As already explained above, if water is used as the fluid 9, it may be preferable to add a lye or base or at least one electrolyte to it. This increases the conductivity of the water due to the presence of ions, and the ions also originate from the two other electrodes 45, 46. In this case, it has proved to be of advantage if at least one laser 50, i.e. the light-emitting part of a laser 50, is disposed in the smoothing section 38, as schematically illustrated in FIG. 1. In particular, this light-emitting part of the laser 50 is in turn disposed in the housing shell 3 or alternatively this light-emitting part of the laser 50 may be shifted farther in the direction towards the longitudinal mid-axis 10 of the reaction chamber 12, i.e. the smoothing section 38, for which purpose appropriate devices may be provided in the housing shell 3, for example plug-in sleeves, etc. Alternatively, it would also be possible to make the housing shell 3 from a trans-parent material and beam the laser light into the smoothing section 38 or into the reaction chamber 12 from outside.

The laser 50 is preferably a red light laser and the laser 50 preferably emits light at a frequency selected from a range with a lower limit of 300 THz and an upper limit of 550 THz.

Based on one embodiment, the laser 50 may emit intermittent light, in which case the laser 50 has an appropriate device for generating this intermittent light or is connected to one. A pulse duration of the laser light pulse may be selected from a range with a lower limit of 20 μs, in particular 33 μs, and an upper limit of 100 μs, in particular 50 μs.

FIG. 4 illustrates what effect applying variable voltage pulses to the fluid 9 has in terms of the degree of efficiency of the device 1 within the meaning of the invention, although again, specific values have been omitted because the intention is merely to draw a relative comparison between the two variants. With the exception of the voltage pulses, all other parameters used for the two variants are the same. One curve 46 plots the degree of efficiency over time using a constant voltage pattern and one curve 47 plots the degree of efficiency of the device 1 using variable voltage patterns such as those illustrated in FIG. 3 for example or described above.

By degree of efficiency in the context of the invention is meant that the ratio of energy picked up to the energy emitted is regarded as heating power.

As clearly illustrated by FIG. 4, a higher degree of efficiency is obtained by feeding variable voltage pules into the reaction chamber 12, thereby making the device 1 more economic to run. It was also found, as also demonstrated by curve 47, that fluctuation in the degree of efficiency is significantly lower than in the case of curve 46.

FIG. 5, finally, illustrates the influence of the wavelength of the light emitted by the light-emitting diodes 43 on the degree of efficiency. As clearly illustrated, the degree of efficiency initially increases in the range around 550 nm and drops again if water is used as the fluid 9.

In terms of the variable intermittent emission of light from the light-emitting diodes 43, a similar correlation to that of FIG. 4 was observed between the degree of efficiency from a constant light source and a variable light source with intermittent light, in keeping with the explanations given above.

As known from the prior art, the heating system 31 may be operated at a pressure of between 2 bar and 4 bar in the primary circuit, for example. However, it would also be possible for the heating system 31 to be operated without pressure in the primary circuit with a temperature of the fluid 9 close to the boiling point of the fluid 9.

Although it has been mentioned at several points that the heating system 31 or device 1 is used to heat houses, this generally applies to the generation of heat irrespective of the purpose for which this heat will ultimately be used. In order to increase the heating power if necessary, it would be possible to connect several devices 1 one after the other, i.e. in series, in the heating system 31.

List of reference numbers

| | |
|---|---|
| 1 | Device |
| 2 | Housing |
| 3 | Housing shell |
| 4 | Housing base |
| 5 | Housing cover |
| 6 | Thread |
| 7 | End region |
| 8 | End region |
| 9 | Fluid |
| 10 | Longitudinal mid-axis |
| 11 | Inlet opening |
| 12 | Reaction chamber |
| 13 | Outlet opening |
| 14 | Anode |
| 15 | Cathode |
| 16 | End region |
| 17 | Orifice |
| 18 | Positive pole |
| 19 | Negative pole |
| 20 | Pulse generator |
| 21 | Shoulder |
| 22 | Bore |
| 23 | External thread |
| 24 | Internal thread |
| 25 | Distance |
| 26 | Opening |
| 27 | Arrow |
| 28 | Radial bore |
| 29 | Axial bore |
| 30 | Bore |
| 31 | Heating system |
| 32 | Radiator |
| 33 | Pump |
| 34 | Expansion tank |
| 35 | Gas absorber |
| 36 | Measuring device |
| 37 | Control unit |
| 38 | Smoothing section |
| 39 | Length |
| 40 | Longitudinal extension |
| 41 | Width |
| 42 | Deflector plate |
| 43 | Light-emitting diode |
| 44 | Device |
| 45 | Laser |
| 46 | Curve |
| 47 | Curve |

1. Device (1) for heating a fluid (9), with a housing (2) comprising a housing shell (3), a housing base (4) and a housing cover (5), with at least one inlet opening (11) and at least one outlet opening (13) for the fluid (9), and at least two electrodes, in particular at least one anode (14) and at least one cathode (15), are disposed in the housing (2) at a distance (25) apart from one another, which are each electrically conductively connected to a pole of at least one pulse generator (20), wherein a smoothing section (38) for the fluid (9) is provided after the electrode(s) in the flow direction—arrow (27)—of the fluid (9), in particular the at least one cathode (15) or the at least one anode (14).

2. Device (1) according to claim 1, wherein the smoothing section (38) is disposed in the housing (2).

3. Device (1) according to claim 1, wherein the smoothing section (38) has a length (39) which is 100% to 500% bigger than a longitudinal extension (40) of at least one of the at least two electrodes, in particular the anode (14) or the cathode (15), in the flow direction of the fluid (9).

4. Device (1) according to claim 1, wherein the housing (2) has an at least partially bigger clearance width (41) in the region of the smoothing section (38) than in the region in which the at least two electrodes, in particular the cathode (15) and the anode (14), are disposed.

5. Device (1) according to claim 1, wherein at least one deflector plate (42) is disposed in the smoothing section (38).

6. Device (1) according to claim 1, wherein at least one light-emitting diode (43) is disposed in the smoothing section (38).

7. Device (1) according to claim 6, wherein the at least one light-emitting diode (43) emits white light.

8. Device (1) according to claim 6, wherein several light-emitting diodes (43) are disposed in the smoothing section (38), which emit light in a different wavelength spectrum.

9. Device (1) according to claim 6, wherein the light-emitting diode(s) (43) are disposed in a peripheral region of the housing shell (3).

10. Device (1) according to claim 6, wherein the light-emitting diodes (43) are electrically conductively connected to a device (44) for generating an intermittent light.

11. Device (1) according to claim 1, wherein at least one of the least two electrodes, in particular the anode (14), is of a basket-shaped design.

12. Device (1) according to claim 11, wherein at least one of the least two electrodes is disposed at least partially inside the basket-shaped electrode, in particular the at least one cathode (15) is disposed at least partially inside the basket-shaped anode (14).

13. Device (1) according to claim 1, wherein the distance (25) between the at least two electrodes, in particular between the cathode (15) and the anode (14), is at least 5 mm.

14. Device (1) according to claim 1, wherein the housing shell (3) is cylindrical in shape.

15. Device (1) according to claim 1, wherein, wherein at least one of the least two electrodes is or are disposed in the housing (2) so as to be relatively displaceable towards the other electrode, in particular the anode (14) is displaceable relative to the cathode (15) and/or the cathode (15) is displaceable relative to the anode (14).

16. Device (1) according to claim 1, wherein the pulse generator (20) is configured to emit variable voltage pulses.

17. Device (1) according to claim 16, wherein the pulse generator (20) generates voltage pulses with an amplitude selected from a range with a lower limit of 330 V and an upper limit of 1500 V.

18. Device (1) according to claim 16, wherein the pulse generator (20) comprises a random number generator.

19. Device (1) according to claim 16, wherein the pulse generator (20) generates voltage pulses with a steep rising flank of at least 25 V/μs.

20. Device (1) according to claim 16, wherein the pulse generator (20) generates rectangular voltage pulses.

21. Device (1) according to claim 16, wherein the pulse generator (20) emits voltage pulses at a pulse frequency selected from a range with a lower limit of 20 Hz and an upper limit of 20 kHz.

22. Device (1) according to claim 16, wherein the pulse generator (20) emits voltage pulses with a pulse duration selected from a range with a lower limit of 2 ns and an upper limit of 10 μs.

23. Device (1) according to claim 16, wherein the pulse generator (20) generates voltage pulses with a pulse pause selected from a range with a lower limit of 2 μs and an upper limit of 20 μs.

24. Device (1) according to claim 23, wherein the pulse generator (20) is configured to generate variable pulse pauses.

25. Device (1) according to claim 1, wherein at least one laser (50) is disposed in the smoothing section (38).

26. Device (1) according to claim 25, wherein the laser (50) emits light at a frequency selected from a range with a lower limit of 300 THz and an upper limit of 550 THz.

27. Device (1) according to claim 25, wherein the laser (50) is connected to a device for generating an intermittently occurring light.

28. Device (1) according to claim 27, wherein the laser (50) emits light pulses and a pulse duration is selected from a range with a lower limit of 20 μs and an upper limit of 100 μs.

29. Device (1) according to claim 1, wherein the pulse generator (20) has a regulating and/or control module or is connected to a regulating and control device.

30. Heating system (31) comprising at least one device for conveying a first fluid (9), at least one device (1) for heating of the fluid (9), at least one heat exchanger in which the heat generated by the fluid (9) is transmitted to another fluid, wherein the at least one device (1) for heating a fluid (9) is as defined according to claim 1.

31. Heating system (31) according to claim 30, wherein the heat exchanger is provided in the form of a radiator (32).

32. Use of the device (1) for heating a fluid (9) according to claim 1 to heat a building.
